(19) United States
(12) Patent Application Publication
(10) Pub. No.: US 2011/0085277 A1
(43) Pub. Date: Apr. 14, 2011

(54) MULTILAYER CHIP CAPACITOR

(75) Inventors: Kang Heon HUR, Suwon (KR); Eun Hyuk Chae, Seoul (KR); Sung Kwon Wi, Seoul (KR); Doo Young Kim, Yongin (KR); Dong Seok Park, Seoul (KR); Byoung Hwa Lee, Seongnam (KR); Sang Soo Park, Suwon (KR); Min Cheol Park, Gwangmyeong (KR); Hae Suk Chunk, Seoul (KR)

(73) Assignee: SAMSUNG ELECTRO-MECHANICS CO., LTD.

(21) Appl. No.: 12/694,926

(22) Filed: Jan. 27, 2010

(30) Foreign Application Priority Data
Oct. 9, 2009 (KR) 10-2009-0096429

(51) Int. Cl. H01G 4/005; H01G 4/002

(52) U.S. Cl. 361/272; 361/303

(57) ABSTRACT

A multilayer chip capacitor includes a capacitor body, a plurality of internal electrodes, and a plurality of external electrodes. The capacitor body is formed of a ceramic sintered product and has first and second side surfaces facing each other. The plurality of internal electrodes each of which has two leads extending to the first and second side surfaces of the capacitor body, respectively, are arranged such that the internal electrodes with one polarity and the internal electrodes with the other polarity are alternately stacked inside the capacitor body. The plurality of external electrodes are formed on the first and second side surfaces of the capacitor body along a stacked direction of the internal electrodes such that the external electrodes with one polarity and the external electrodes with the other polarity are alternately arranged on each of the first and second side surfaces, and are connected to the leads.

### CROSS-REFERENCE TO RELATED APPLICATIONS

This application claims the priority of Korean Patent Application No. 10-2009-0096429 filed on Oct. 9, 2009, in the Korean Intellectual Property Office, the disclosure of which is incorporated herein by reference.

### BACKGROUND OF THE INVENTION

1. Field of the Invention

The present invention relates to a multilayer chip capacitor, and more particularly, to a multi-terminal multilayer chip capacitor which improves equivalent serial inductance (ESL) and equivalent serial resistance (ESR) characteristics and solves peel-off and surface flatness problems caused by variation in thickness.

2. Description of the Related Art

Multilayer chip capacitors may be effectively used as decoupling capacitors disposed in large scale integration (LSI) power supply circuits or capacitive parts for removing high-frequency noise in a signal line. To stabilize the power supply circuit, the multilayer chip capacitor should have a low ESL value.

Such a requirement is further increasing in accordance with a trend for high frequency and high current electronic devices. The stability of the power supply circuit depends on the ESR as well as ESL of the multilayer chip capacitor. When the ESR has too small a value, the stability of the power supply circuit decreases, so that a voltage rapidly varies when resonance occurs. Therefore, the ESR needs to be maintained at a proper value.

U.S. Pat. No. 5,880,925 discloses a surface mount multilayer capacitor in which leads of first and second internal electrodes having different polarities are disposed adjacent to each other in an interdigitated arrangement, in order to reduce ESL. In this case, since voltages having different polarities are supplied to the adjacent leads, a magnetic flux generated by high frequency current flowing from an external electrode is offset between the adjacent leads. Therefore, ESL decreases.

However, since resistances generated from four leads of each internal electrode are connected in parallel, the overall resistance of the capacitor decreases to a very small value. As a result, the ESR of the capacitor also decreases to a very small value. When the ESR is very low, a power supply circuit is unstabilized.

U.S. Pat. No. 6,441,459 discloses a multilayer electronic device in which each of the internal electrodes uses only one lead, in order to prevent ESR from becoming too low. According to the disclosure, however, since each of the internal electrodes has only one lead, ESL increases by a small amount. Furthermore, since the internal electrodes having the same polarity are not electrically connected to one another in the capacitor, it is not easy to perform an electrostatic capacity test for the capacitor.

In a high capacity multilayer chip capacitor in which the number of stacked layers increases because of a reduction in the number of leads, a thickness variation may occurs due to a difference in the number of leads present, depending on their positions. Such a thickness variation may not only cause a peel-off problem, but also reduce the surface flatness of the multilayer chip capacitor. Consequently, mounting may be performed in such a manner as to make the MLCC defective. Even in a low capacity multilayer chip capacitor having a small number of stacked layers, the number of internal electrodes (leads) contacting external electrodes decreases. Therefore, the adhesive force of the external electrodes may decrease.

### SUMMARY OF THE INVENTION

An aspect of the present invention provides a multilayer chip capacitor having a structure which maintains equivalent serial inductance (ESL) and reduces equivalent serial resistance (ESR) and of which an electrostatic capacity test is easily performed and capable of solving a problem caused by a thickness variation due to a reduction in the number of leads.

According to an aspect of the present invention, there is provided a multilayer chip capacitor including: a capacitor body formed of a ceramic sintered product and having first and second side surfaces facing each other; a plurality of internal electrodes each having two leads extending to the first and second side surfaces of the capacitor body, respectively, and arranged so that the internal electrodes with one polarity and the internal electrodes with the other polarity are alternately stacked inside the capacitor body; and a plurality of external electrodes formed on the first and second side surfaces of the capacitor body along a stacked direction of the internal electrodes such that the external electrodes with one polarity and the external electrodes with the other polarity are alternately arranged on each of the first and second side surfaces, and connected to the leads. One lead of each of the internal electrodes extending to the first side surface is connected to an external electrode offset by the position of an external electrode connected to the other lead extending to the second side surface. The leads of the internal electrodes are arranged in a zigzag pattern along the stacked direction of the internal electrodes, when seen from each of the first and second side surfaces.

The number of leads connected to at least one external electrode may be different from the number of leads connected to each of the other external electrodes. At each level in which one internal electrode is formed, at least one dummy pattern may be formed at positions which are electrically separated from the one internal electrode and overlap the leads of other electrodes in a thickness direction, such that a thickness variation caused by the difference in the number of leads is reduced.

The plurality of dummy patterns may be formed, and the numbers of dummy patterns and leads connected to the respective external electrodes may be equal to one another.

At each level in which one internal electrode is formed, the plurality of dummy patterns may be formed at positions at which the leads are not formed in the internal electrode and which overlap the leads of the other internal electrodes in the thickness direction.

The at least one dummy patterns may be formed to be connected to the external electrodes.

The eight (first to eighth) external electrodes may be provided such that four external electrodes are formed on each of the first and second side surfaces. When the first to eighth external electrodes are designated along one circulation direction, the first to fourth external electrodes may be sequentially arranged on the first side surface, and the fifth to eighth external electrodes may be sequentially arranged on the second side surface.

The plurality of internal electrodes may include m-th and n-th internal electrodes (where 1≦m≦3 and 4≦n≦6, m and n are integers) each of which has two leads connected to different external electrodes depending on the stacked order. The m-th internal electrode may be connected to the m- and (8−m)-th external electrodes, respectively, and the n-th internal electrode may be connected to the (8−n)- and (n+2)-th external electrodes, respectively.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of an internal-electrode structure of a multilayer chip capacitor according to an embodiment of the present invention;

FIG. 2 is a perspective view of the capacitor of FIG. 1;

FIG. 3 is a diagram illustrating an arrangement of leads and dummy patterns extending to a side surface of the capacitor body in the capacitor of FIG. 2;

FIG. 4 is a plan view of an example of a printing screen pattern for internal electrodes which may be applied to the capacitor of FIG. 1;

FIG. 5 is a plan view of an example of a printing screen pattern for internal electrodes which may be applied to a multilayer chip capacitor according to another embodiment of the present invention;

FIG. 6 is a side view of the multilayer chip capacitor of FIG. 5, illustrating an arrangement of leads and dummy patterns extending to one side surface of a capacitor body;

FIG. 7A is a graph obtained by measuring a thickness variation of a multilayer chip capacitor according to the related art; and

FIG. 7B is a graph obtained by measuring a thickness variation of a multilayer chip capacitor according to a comparative embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

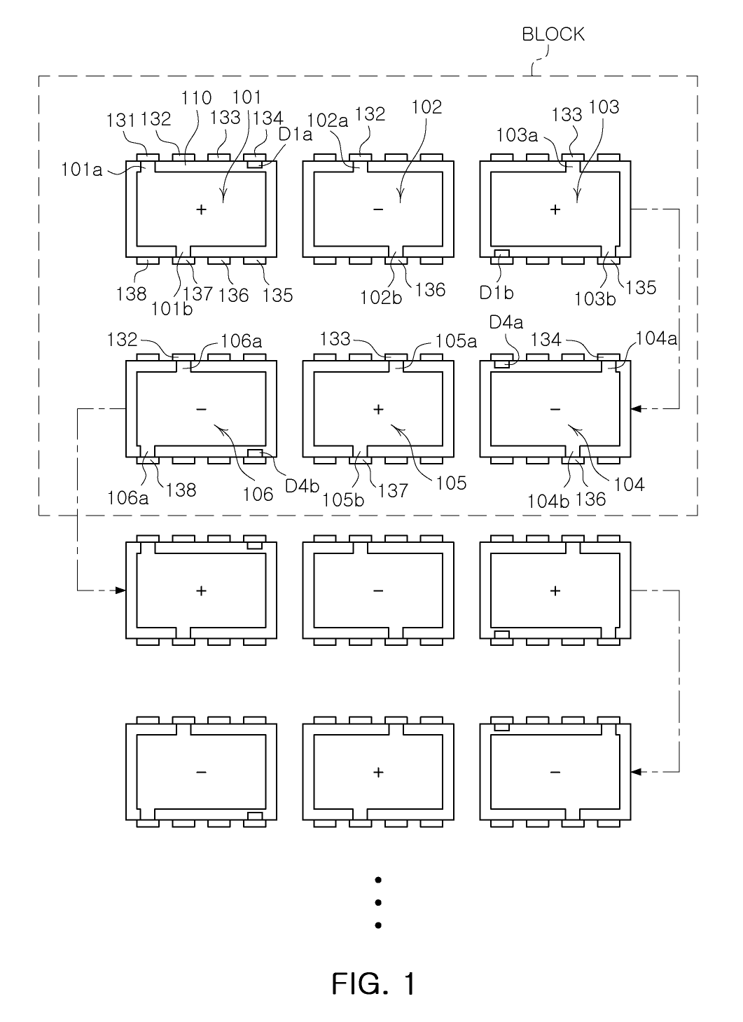

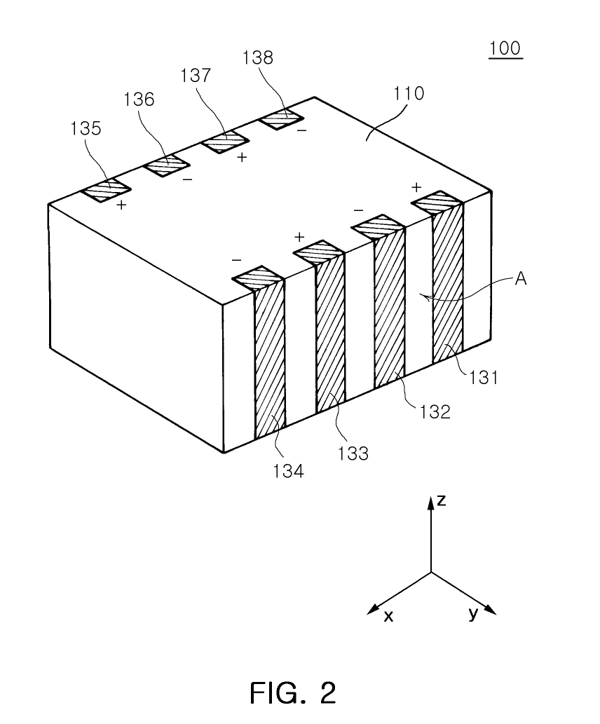

FIG. 1 is a cross-sectional view of an internal-electrode structure of an eight-terminal (eight-electrode) multilayer chip capacitor according to an embodiment of the present invention. FIG. 2 is a perspective view of the multilayer chip capacitor illustrated in FIG. 1.

Referring to FIGS. 1 and 2, the capacitor 100 includes a capacitor body 110 and first to eight external electrodes 131 to 138 formed on both side surfaces of the capacitor body 110 facing each other.

The capacitor body 110 is formed by stacking a plurality of dielectric layers 110′. Inside the capacitor body 110, first to sixth internal electrodes 101 to 106 are disposed to be separated from one another by the respective dielectric layers 110′.

As the internal electrode with one polarity and the internal electrode with the other polarity are alternately disposed so as to face each other with the dielectric layer 110′ interposed therebetween, the internal electrodes 101 to 106 form capacitance. On a first side surface A of the capacitor body 110 and a second side surface opposed to the first side surface A, external electrodes having different polarities are alternately disposed.

Referring to FIG. 1, the first to sixth internal electrodes 101 to 106 are sequentially stacked to form a single block. That is, as the first to sixth internal electrodes 101 to 106 are sequentially disposed along a stacked direction (refer to a dashed dotted line arrow), a basic unit (block) having a periodic multilayer structure is formed. The capacitor body 110 is formed by stacking the blocks repeatedly.

In FIG. 1, the first to sixth internal electrodes 101 to 106 form a single block (indicated by a dotted line) with the first internal electrode 101 set to a start point. However, a start point of one block may be arbitrarily determined. For example, a single block may be set to have an order such that the second to sixth internal electrodes 102 to 106 are disposed initially with the first internal electrode 101 in the final position. Whether or not a block has an internal electrode set to a start point, the block is composed of six continuous internal electrodes.

The internal electrodes 101 to 106 have two leads 101a and 101b, 102a and 102b, 103a and 103b, 104a and 104b, 105a and 105b, and 106a and 106b, respectively. One lead (for example, 101a) of the two leads (for example, 101a and 101b) of each of the internal electrodes extends to the first side surface A, and the other lead extends to the second side surface opposed to the first side surface A. Since each of the internal electrodes has only two leads, an excessive reduction in equivalent series resistance (ESR) may be suppressed, and proper ESR may be maintained.

In each of the internal electrodes 101 to 106, one lead extending to the first side surface A and corresponding to an external electrode is offset by the position of the next external electrode from the other lead extending to the second side surface, as illustrated in FIG. 1.

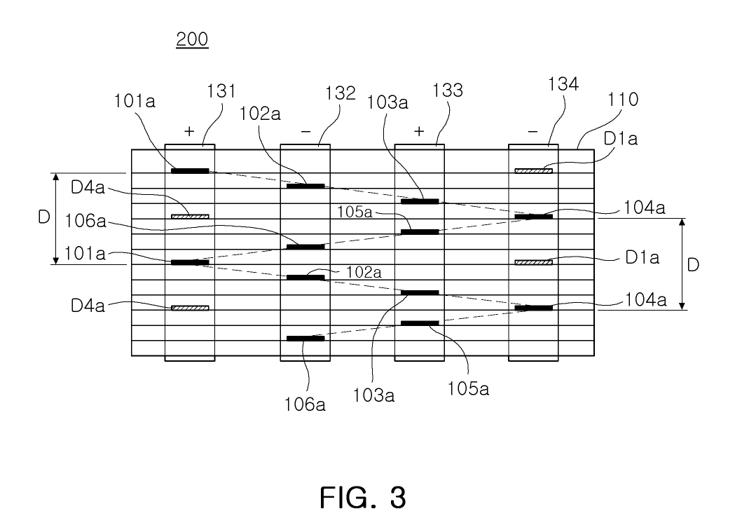

For example, the lead 101a extending to the first side surface in the first internal electrode 101 is offset to the left by the position of the next external electrode from the lead 101b extending to the second side surface. As the leads having such an offset arrangement are disposed in a zigzag pattern along the stacked direction (refer to FIG. 3), all internal electrodes having the same polarity are electrically connected to one another in the capacitor.

More specifically, the first internal electrode 101 having a positive polarity is electrically connected to the fifth internal electrode 105 having a positive polarity through the seventh external electrode 137 connected to the lead 101b, the fifth internal electrode 105 having a positive polarity is electrically connected to the third internal electrode 103 having a positive polarity through the third external electrode 133 connected to the lead 105a. Accordingly, all internal electrodes having a positive polarity, that is, the first, third, and fifth internal electrodes 101, 103, and 105 are electrically connected to one another within the capacitor.

Furthermore, the second internal electrode 102 having a negative polarity is electrically connected to the sixth internal electrode 106 through the second external electrode 132 connected to the lead 102a, and electrically connected to the fourth internal electrode 104 through the sixth external electrode 136 connected to the lead 102b. Accordingly, all internal electrodes having a negative polarity, that is, the second, fourth, and sixth internal electrodes 102, 104, and 106 are electrically connected to one another in the capacitor.

When the internal electrodes having the same polarity are electrically connected to one another in the capacitor without an electrode pad of an external substrate or an external connection member, performing an electrostatic capacity test after the capacitor is manufactured is facilitated. That is, when all internal electrodes having the same polarity are connected to one another in the capacitor, positive and negative probes of an electrostatic capacity testing device may be connected to only two external electrodes having different polarities to perform an electrostatic capacity test for the entire capacitor. However, when any one of the internal electrodes is not connected to the other internal electrodes having the same polarity, the capacitor should be mounted on an external substrate having a connection member such as an electrode pad or an external connector member should be used in order to test the overall capacity of the capacitor.

According to this embodiment of the present invention, the leads of the neighboring internal electrodes having different polarities (for example, the positive leads 101a and 101b and the negative leads 102a and 102b) are disposed so as to be permanently adjacent to each other, seen from the stacked direction (the “z” direction of FIG. 2). Accordingly, it is possible to minimize ESR in the capacitor.

Furthermore, referring to FIG. 3, the leads extending to each of the side surfaces of the capacitor body 110 are disposed in a zigzag pattern along the stacked direction, viewed from the side surface.

FIG. 3 is a diagram illustrating the arrangement of the leads extending to the first side surface A of the capacitor body in the capacitor of FIG. 2.

In the arrangement of FIG. 3, the number of leads connected to each of the external electrodes 131 and 134 is different from the number of leads connected to each of the external electrodes 132 and 134. That is, considering only the number of leads, the number of leads existing in the thickness direction differs. Therefore, a thickness variation may occur.

Referring to FIG. 3, the leads 101a to 104a of the first to fourth internal electrodes extending to the first side surface A are disposed to be connected to the first to fourth external electrodes 131 to 134, respectively. The lead 105a of the fifth internal electrode is disposed to be connected to the third external electrode 133, and the lead 106a of the sixth internal electrode is disposed to be connected to the second internal electrode.

As a result, while the number of leads connected to each of the second and third external electrodes 132 and 133 is four, the number of leads connected to each of the first and fourth external electrodes 131 and 134 is only two. Therefore, due to such a difference in the number of leads contacting each external electrode, a thickness variation may occur in the multilayer chip capacitor. Accordingly, a peel-off problem may occur.

In this embodiment, dummy patterns D1a, D1b, D4a, and D4b are provided in order to solve the problem caused by the difference in the number of leads. Each of the dummy patterns corresponding to a single internal electrode is formed at a position corresponding to the lead of another internal electrode.

Each of the dummy patterns D1a, D1b, D4a, and D4b adopted in this embodiment is formed at a region which is electrically separated from the corresponding internal electrode in the dielectric layer where the internal electrode is formed, and overlaps the lead of another electrode in the thickness direction.

Then, the number of leads and dummy patterns connected to the respective external electrodes may be equalized. Therefore, it is possible to effectively prevent the problem caused by the differences in the number of leads.

As shown in FIG. 1, each of the dummy patterns D1a, D1b, D4a, and D4b may extend to the corner so as to be connected to the corresponding external electrode. In this case, the dummy patterns having such a form may not only reduce the thickness variation, but also increase the adhesive force of the external electrodes.

Such leads are arranged in a zigzag pattern along the stacked direction, and the differences in the number of leads may be compensated for by the dummy patterns. Such an arrangement may be applied to the second side surface facing the first side surface A, which will be sufficiently understood by those skilled in the art with reference to FIG. 1.

Such a zigzag lead pattern provides an advantage of reducing mutual inductance between the leads which are vertically adjacent (in the stacked direction) and have the same polarity. Referring to FIG. 3, an average distance between leads which are vertically adjacent to each other and connected to the same external electrode is larger than the total thicknesses of two dielectric layers. For example, a distance between the leads 101a which are vertically adjacent to each other and connected to the external electrode 131 substantially corresponds to the total thicknesses D of six dielectric layers. When the distance between the vertically adjacent leads having the same polarity increases, mutual inductance caused by a magnetic combination between the leads decreases or is suppressed. Accordingly, the capacitor ESL is further reduced.

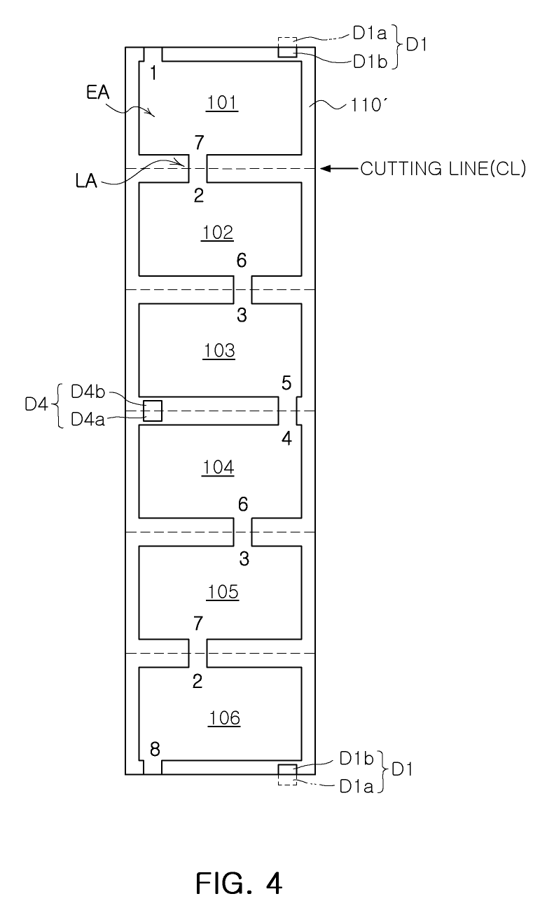

FIG. 4 is a plan view of an example of a screen printed pattern for internal electrodes which may be applied to the capacitor of FIG. 2. Each of the internal electrodes is formed in an electrode pattern region EA which is opened by a screen region on the dielectric layer 110′. As the screen printed pattern illustrated in FIG. 4 is prepared, lead regions of the internal electrodes adjacent in the stacked direction meet each other. For example, a lead region 7 corresponding to reference numeral 101b of FIG. 2 meets a lead region 2 corresponding to reference numeral 102a of FIG. 2.

When the lead regions of the vertically adjacent internal electrodes meet each other in the layout of the printing screen pattern to form one region LA, there is an advantage in that the leads are prevented from being opened from the external electrodes due to a cutting error caused during a manufacturing process. Similarly, continuous patterns D1 and D4 for forming two dummy patterns D1a and D1b and D4a and D4b, respectively, are formed to be spaced apart from the internal electrodes, but formed across two dielectric layers which are to be cut. Then, connection with the external electrodes may be guaranteed to increase the adhesive strength thereof. Furthermore, the thickness variation may be effectively reduced through more accurate alignment.

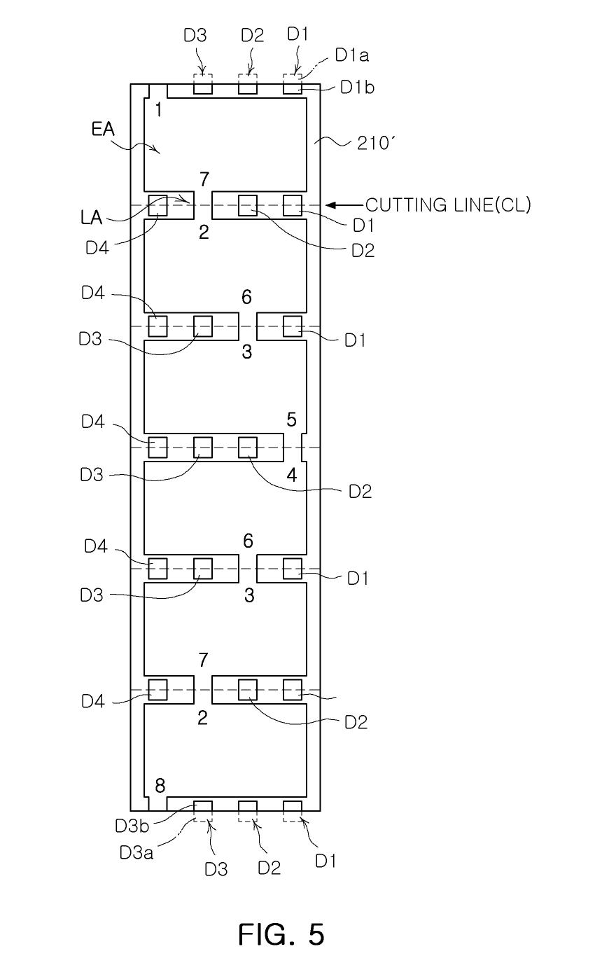

In the above described embodiment, additional dummy patterns are formed in specific external electrodes in order to implement a multilayer chip capacitor in which the numbers of leads and dummy patterns connected to the respective external electrodes are equalized. However, although at least one dummy pattern is adopted, it may be adopted to reduce the differences in the number of leads. In each of the dielectric layers having an internal electrode formed therein, dummy patterns may be formed at positions at which leads are not formed in the internal electrode and which overlap the leads of other internal electrodes in the thickness direction. The layout of a screen pattern having such a form is illustrated in FIG. 5.

Similar to FIG. 4, first to sixth internal electrodes 201 to 206 each having two leads are formed on a dielectric layer. However, continuous patterns D1 to D4 for two dummy patterns, respectively, are formed at positions at which leads are not formed in the corresponding internal electrode and which correspond to the leads of the other internal electrodes.

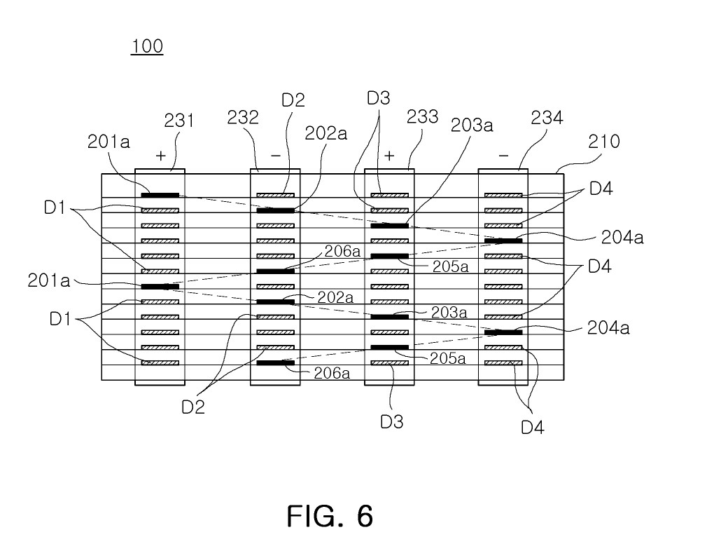

FIG. 6 illustrates a side cross-section of a multilayer chip capacitor which is implemented using the respective dielectric layers obtained from the layout of the screen pattern illustrated in FIG. 5.

Referring to FIG. 6, leads 201a to 204a of first to fourth internal electrodes extending to one side surface are disposed to be connected to first to fourth external electrodes 231 to 234, respectively, a lead 205a of a fifth internal electrode is disposed to be connected to the third external electrode 233, and a lead 206a of a sixth internal electrode is disposed to be connected to the second external electrode 232, similar to the arrangement illustrated in FIG. 3.

In this embodiment, the dummy patterns D1 to D4 are adopted at all positions corresponding to the leads of the other internal electrodes. Then, the numbers of leads and dummy patterns connected to the respective external electrodes are equalized at 12.

According to this embodiment of the present invention, the problem caused by a difference in the number of leads may be effectively prevented, and the adhesive force of the external electrodes may be significantly improved.

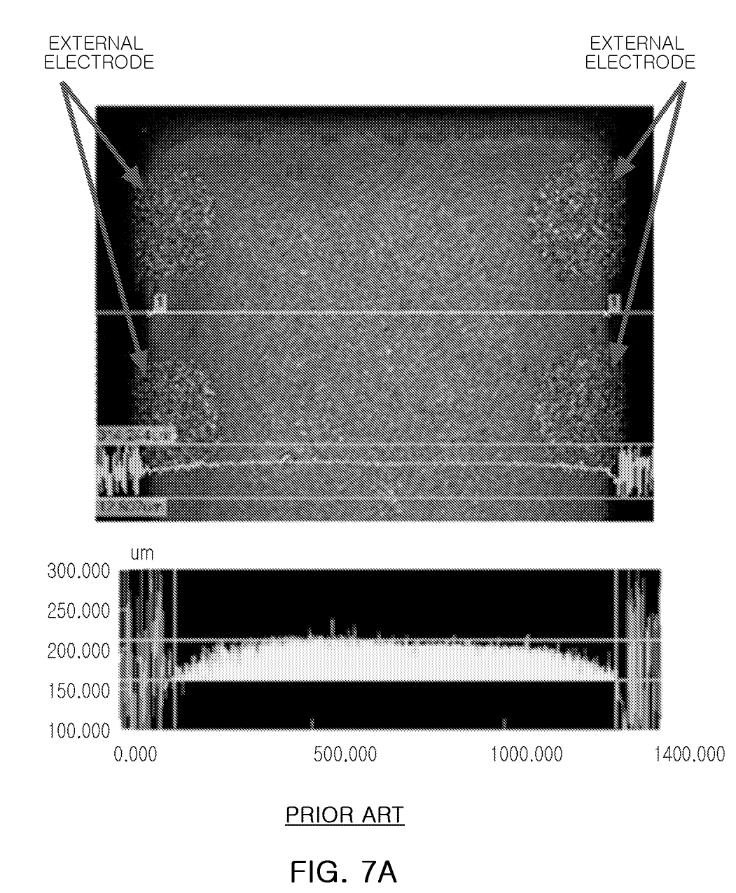

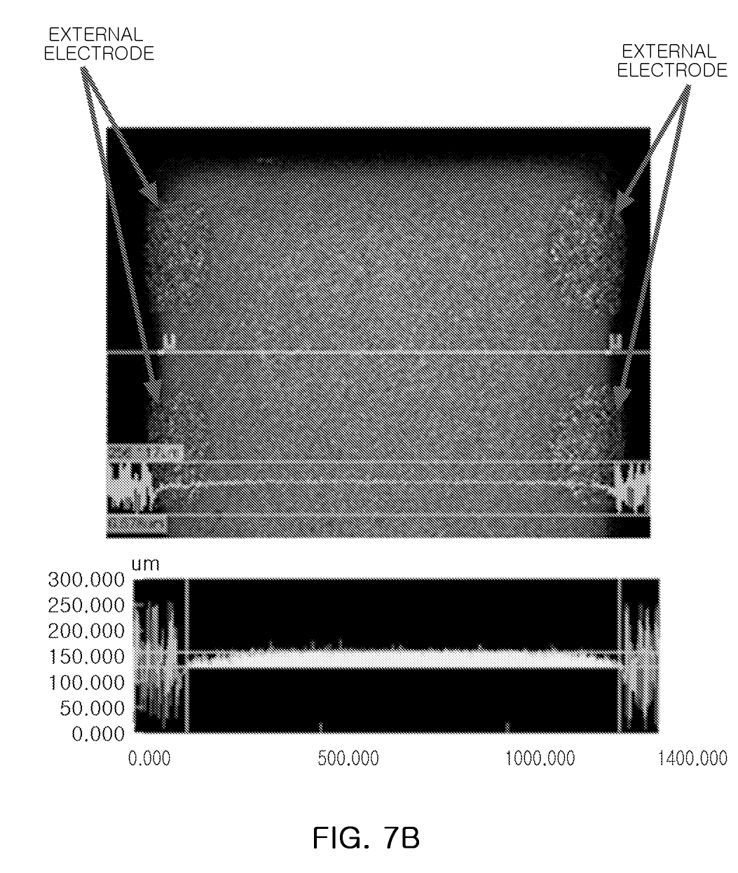

In order to check an effect according to the embodiment of the present invention, a multilayer chip capacitor (FIG. 7A) which has a similar structure to that illustrated in FIG. 6 excluding the dummy patterns was compared with a multilayer chip capacitor (FIG. 7B) which has a similar structure to that illustrated in FIG. 6 including the dummy patterns to examine a thickness variation. It can be seen that the thickness variation of the multilayer chip capacitor of FIG. 7A according to the embodiment of the present invention was significantly reduced in comparison with that of FIG. 7A.

According to the embodiment of the present invention, the capacitor ESR is prevented from becoming excessively low, and ESL is further reduced. Accordingly, it is possible to improve the stability of the power supply circuit. Furthermore, since all internal electrodes having the same polarity are electrically connected to one another inside the capacitor without an external connection member, it is easy to perform an electrostatic capacity test. In addition, since the number of leads exposed to the respective terminals is equal, it is possible to prevent a peel-off problem caused by a difference in the number of exposed leads. Accordingly, the flatness of the chip surface may be improved, and an area of the internal electrode in contact with the external electrode may be increased to improve the adhesive force of the external electrode.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer chip capacitor comprising:
a capacitor body formed of a ceramic sintered product and having first and second side surfaces facing each other;
a plurality of internal electrodes each having two leads extending to the first and second side surfaces of the capacitor body, respectively, and arranged so that the internal electrodes with one polarity and the internal electrodes with the other polarity are alternately stacked inside the capacitor body; and
a plurality of external electrodes formed on the first and second side surfaces of the capacitor body along a stacked direction of the internal electrodes such that the external electrodes with one polarity and the external electrodes with the other polarity are alternately arranged on each of the first and second side surfaces, and connected to the leads,
wherein one lead of each of the internal electrodes extending to the first side surface is connected to an external electrode offset by the position of an external electrode connected to the other lead extending to the second side surface,
the leads of the internal electrodes are arranged in a zigzag pattern along the stacked direction of the internal electrodes, when seen from each of the first and second side surfaces,
the number of leads connected to at least one external electrode is different from the number of leads connected to each of the other external electrodes, and
at each level in which one internal electrode is formed, at least one dummy pattern is formed at positions which are electrically separated from the one internal electrode and overlap the leads of other electrodes in a thickness direction, such that a thickness variation caused by the difference in the number of leads is reduced.

2. The multilayer chip capacitor of claim 1, wherein the plurality of dummy patterns are formed, and the numbers of dummy patterns and leads connected to the respective external electrodes are equal to one another.

3. The multilayer chip capacitor of claim 1, wherein at each level in which one internal electrode is formed, the plurality of dummy patterns are formed at positions at which the leads are not formed in the internal electrode and which overlap the leads of the other internal electrodes in the thickness direction.

4. The multilayer chip capacitor of claim 1, wherein the at least one dummy pattern is formed to be connected to the external electrodes.

5. The multilayer chip capacitor of claim 4, wherein the eight (first to eighth) external electrodes are provided such that four external electrodes are formed on each of the first and second side surfaces, and
when the first to eighth external electrodes are designated along one circulation direction, the first to fourth external electrodes are sequentially arranged on the first side surface, and the fifth to eighth external electrodes are sequentially arranged on the second side surface.

6. The multilayer chip capacitor of claim. 5, wherein the plurality of internal electrodes comprise m-th and n-th internal electrodes (where 1≦m≦3 and 4≦n≦6, m and n are integers) each of which has two leads connected to different external electrodes depending on the stacked order,
the m-th internal electrode is connected to the m- and (8−m)-th external electrodes, respectively, and
the n-th internal electrode is connected to the (8−n)- and (n+2)-th external electrodes, respectively.
